(19) United States
(12) Patent Application Publication
(10) Pub. No.: US 2023/0131359 A1
(43) Pub. Date: Apr. 27, 2023

(54) System and Method for Generating Synthetic Cohorts Using Generative Modeling

(71) Applicant: Nuance Communications, Burlington, MA (US)

(72) Inventors: Haydar Talib, Montreal (CA); Claudio Vair, Borgone Susa (IT); Kevin Robert Farrell, Brick, NJ (US); Daniele Ernesto Colibro, Alessandria (IT)

(21) Appl. No.: 17/962,040

(22) Filed: Oct. 7, 2022

Related U.S. Application Data
(60) Provisional application No. 63/272,410, filed on Oct. 27, 2021.

(51) Int. Cl. G10L 17/04; G10L 17/26

(52) U.S. Cl. CPC G10L 17/04; G10L 17/26

(57) ABSTRACT

A method, computer program product, and computing system for generating a generative model representative of a plurality of natural biometric profiles. A plurality of random samples are generated from the generative model. A plurality of synthetic biometric profiles are generated based upon, at least in part, the plurality of random samples.

### RELATED APPLICATION(S)

This application claims the benefit of U.S. Provisional Application No. 63/272,410 filed on 27 Oct. 2021, the entire contents of which is incorporated herein by reference.

### BACKGROUND

The goal of a biometric verification system is to produce recognition scores that measure the likelihood that a biometric profile (e.g., a voiceprint) and an unknown biometric sample or segment belong to the same individual. For instance, in a speaker verification system, the recognition score is compared to a predefined threshold for deciding if a voiceprint and the target speech segment are from the same person. Score normalization is a widely used technique that allows the biometric recognition scores to be calibrated. Examples of these score normalization techniques include ZNorm, TNorm, and SNorm. However, these conventional score normalization techniques use and potentially expose sensitive biometric information used to identify an individual in ways that are not permissible by laws, policies, or the interests of the entities and individuals using a biometric verification system.

### BRIEF DESCRIPTION OF THE DRAWINGS

FIG. 1 is a flow chart of one implementation of the synthetic cohort generation process;

FIG. 2 is a diagrammatic view of a plurality of natural biometric profiles;

FIG. 3 is a diagrammatic view of a generative model generated in accordance with one implementation of the synthetic cohort generation process;

FIG. 4 is a diagrammatic view of a plurality of random points generated in accordance with one implementation of the synthetic cohort generation process;

FIG. 5 is a diagrammatic view of the synthetic cohort generation process;

FIG. 6 is a diagrammatic view of the synthetic cohort being used during score normalization within a biometric verification system in accordance with one implementation of the synthetic cohort generation process;

FIG. 7 is an example of a graphical comparison of score normalization using natural biometric profiles and synthetic biometric profiles; and

FIG. 8 is a diagrammatic view of a computer system and the synthetic cohort generation process coupled to a distributed computing network.

Like reference symbols in the various drawings indicate like elements.

### DETAILED DESCRIPTION OF THE PREFERRED EMBODIMENTS

As will be discussed in greater detail below, implementations of the present disclosure generate synthetic (i.e., artificial) biometric profiles from natural or actual biometric profiles representative of biometric information of particular individuals using generative modelling. Biometric profiles are representations of biometric information that are attributable to particular individuals. For example, biometric profiles include voiceprints, face prints, retinal scans, fingerprints, conversation prints (i.e., a behavioural biometric based upon an individual's unique use of language (e.g., usual vocabulary and expressions)), or any other biological feature that uniquely identifies a particular individual or person. As noted above, biometric verification systems compare known biometric profiles and typically use score normalization to calibrate biometric recognition scores generated when comparing biometric profiles to a target biometric sample. However, conventional score normalization techniques use and potentially expose sensitive biometric information in ways that are not permissible by laws, policies, or the interests of the entities and individuals. As will be discussed in greater detail below, the present disclosure uses a generative model generated from a plurality of natural biometric profiles to generate synthetic biometric profiles with the same distribution of biometric characteristics as the plurality of natural biometric profiles. In this manner, score normalization is possible when performing biometric verification without exposing natural or actual biometric profiles and without reducing verification accuracy.

The details of one or more implementations are set forth in the accompanying drawings and the description below. Other features and advantages will become apparent from the description, the drawings, and the claims.

### The Synthetic Cohort Generation Process:

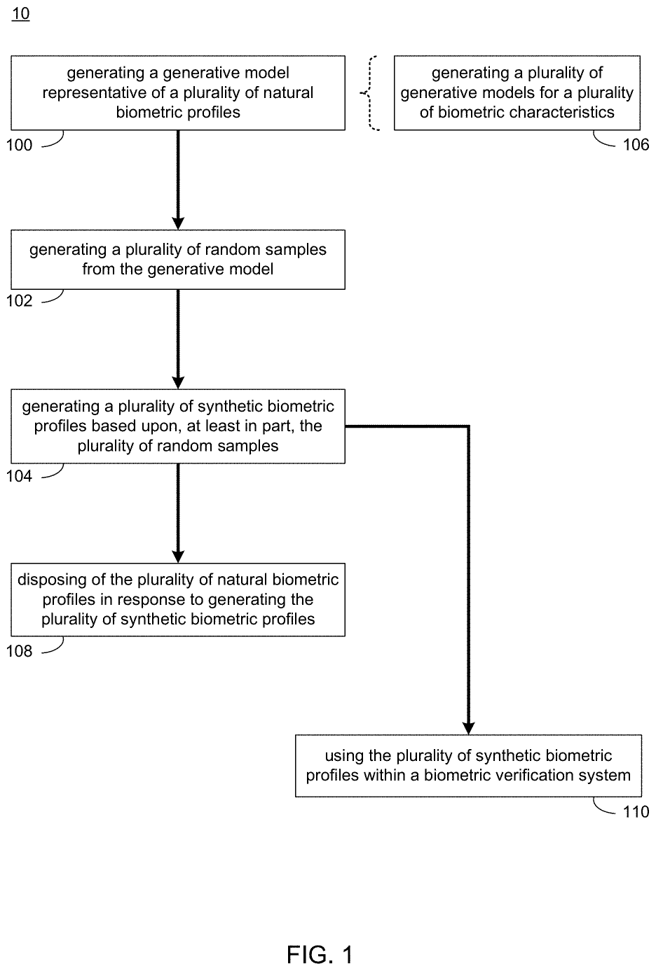

Referring also to FIGS. 1-8, synthetic cohort generation process 10 generates 100 a generative model representative of a plurality of natural biometric profiles. A plurality of random samples are generated 102 from the generative model. A plurality of synthetic biometric profiles are generated 104 based upon, at least in part, the plurality of random samples.

As discussed above, a biometric profile is a representation of biometric information that is attributable to a particular person. For example, biometric profiles include voiceprints, face prints, retinal scans, fingerprints, or any other biological feature that uniquely identifies a particular individual or person. As noted above, biometric verification systems compare known biometric profiles and typically use score normalization to calibrate biometric recognition scores generated when comparing biometric profiles to a target biometric sample. However, conventional score normalization techniques use and potentially expose sensitive biometric information in ways that are not permissible by laws, policies, or the interests of the entities and individuals. As will be discussed in greater detail below, the present disclosure uses a generative model generated from a plurality of natural biometric profiles to generate synthetic biometric profiles with the same distribution of biometric characteristics as the plurality of natural biometric profiles. In this manner, score normalization is possible when performing biometric verification without exposing natural/actual biometric profiles and without reducing verification accuracy.

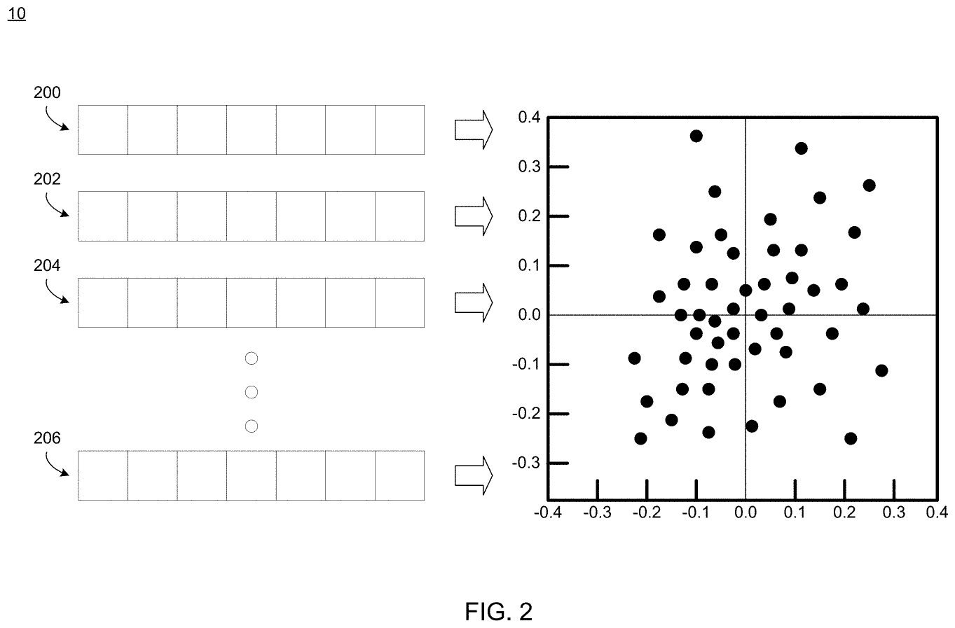

In some implementations, synthetic cohort generation process 10 generates 100 a generative model representative of a plurality of natural biometric profiles. As discussed above, a biometric profile is a representation of biometric information that uniquely identifies a particular individual or person. A natural biometric profile is a biometric profile attributable to a real person. In some implementations, a natural biometric profile includes a vector of biometric information associated with an individual. Referring also to FIG. 2, a plurality of natural biometric profiles are shown (e.g., biometric profiles 200, 202, 204, 206). In some implementations, biometric profiles 200, 202, 204, 206 are vectors of biometric information. In one example, biometric profiles 200, 202, 204, 206 are voiceprints of particular individuals. In some implementations, the vectors are “i-vectors” that are extracted from speech signals from an individual. An i-vector or intermediate vector is a representation of a speech signal generated by extracting and processing particular signal features from the speech signal. In another example, the vectors are “x-vectors” which are embeddings extracted with a neural network or other machine learning models. In this manner, biometric profiles may be compared and evaluated using a vector representation. For example and as shown in FIG. 2, biometric profiles 200, 202, 204, 206 are represented as individual points within the graph of biometric profiles. As will be discussed in greater detail below, synthetic cohort generation process 10 uses the distribution of biometric profiles 200, 202, 204, 206 to generate a generative model and for generating synthetic biometric profiles.

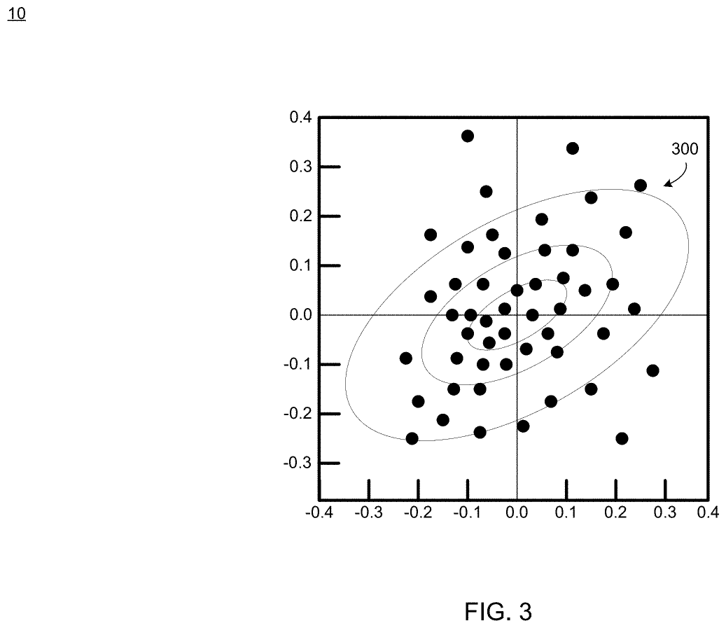

In some implementations, synthetic cohort generation process 10 generates 100 a generative model representative of the plurality of natural biometric profiles. A generative model is a statistical model of the joint probability distribution on a given observable variable (e.g., “X”) and a target variable (e.g., “Y”). Specifically, a generative model describes how a dataset is generated, in terms of a probabilistic model. By sampling from this model, new data is generated. Examples of generative models include a multivariate Gaussian distribution, Bayesian networks, Markov random fields, Hidden Markov Models (HHMs), Generative Adversarial Networks (GANs), etc. Referring also to the example of FIG. 3, synthetic cohort generation process 10 generates a generative model (e.g., generative model 300 shown with concentric rings defining the distribution of natural biometric profiles in a graph of biometric profiles) representative of the distribution of natural biometric profiles 200, 202, 204, 206. In this example, generative model 300 defines the distribution of the plurality of natural biometric profiles for particular variables or parameters.

In some implementations, generating 100 the generative model includes generating 106 a plurality of generative models for a plurality of biometric characteristics. As discussed above, biometric profiles associate specific biometric information with particular individuals for various biometric characteristics. Biometric characteristics are defined for various types of biometric information. For the example of voice/speech biometrics, the plurality of biometric characteristics include a plurality of voice/speech characteristics. In one example, the plurality of voice characteristics include speaker age, speaker language, and/or speaker gender. For instance, these voice characteristics may impact the distribution of particular biometric profiles. Suppose the plurality of biometric profiles include 50% English speakers and 50% German speakers. In this example, the voice characteristics resulting from different languages may introduce distinct distributions in the plurality of biometric profiles. Accordingly, synthetic cohort generation process 10 generates 106 a plurality of generative modes (e.g., a generative model for English speakers and a generative model for German speakers).

In another example, suppose that the plurality of biometric profiles include 33% speakers with ages ranging from 18-30 years old, 33% speakers with ages ranging from 31-50 years old, and 33% speakers with ages ranging from 51-75 years old. In this example, the voice characteristics resulting from different ages may introduce distinct distributions in the plurality of biometric profiles. Accordingly, synthetic cohort generation process 10 generates 106 a plurality of generative modes (e.g., a generative model for 18-30 year old speakers, a generative model for 31-50 year old speakers, and a generative model for 51-75 year old speakers).

In some implementations, synthetic cohort generation process 10 generates 100 a generative model for a plurality of biometric profiles with multiple biometric characteristics. In one example, suppose that the plurality of biometric profiles include fingerprints from individuals with ages ranging from 18-30 years old and from individuals of one gender. In this example, synthetic cohort generation process 10 generates a generative model specifically for these individuals with multiple, known biometric characteristics (e.g., 18-30 years old and a single gender). In this manner, synthetic cohort generation process 10 generates 106 a generative model that accounts for multiple biometric characteristics.

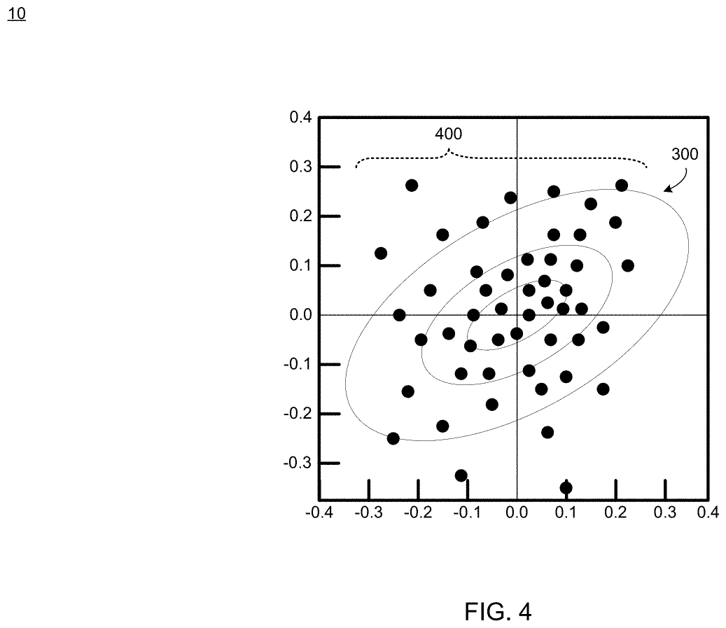

In some implementations, synthetic cohort generation process 10 generates 102 a plurality of random samples from the generative model. A random sample from the generative model is any value or combination of values (e.g., a vector of biometric information) that adheres to the distribution of values of the generative model. For example and referring also to FIG. 4, synthetic cohort generation process 10 generates a plurality of random samples (e.g., plurality of random samples 400) from generative model 300 that have the same distribution of values as generative model 300. In this manner, plurality of random samples 400 hold the same statistical characteristics as the plurality of natural biometric profiles but do not include the same biometric information as the plurality of natural biometric profiles. Retaining the statistical characteristics of the generative model generated for the plurality of natural biometric profiles is important because of score normalization. As discussed above, when using biometric profiles during biometric verification, a recognition score is compared to a predefined threshold for deciding if a biometric profile and the target biometric input are from the same person. Score normalization allows the biometric recognition scores to be calibrated for expected biometric values. Accordingly, by using a generative model (e.g., generative model 300) to define the distribution of the plurality of natural biometric profiles, synthetic cohort generation process 10 is able to generate 102 a plurality of random samples (e.g., plurality of random samples 400) that fit or adhere to the distribution of the plurality of natural biometric profiles. In this manner, score normalization using the plurality of random samples represents the plurality of natural biometric profiles without exposing any biometric information from real biometric profiles.

In some implementations, synthetic cohort generation process 10 generates 104 a plurality of synthetic biometric profiles based upon, at least in part, the plurality of random samples. Synthetic biometric profiles are artificial biometric profiles that have biometric information that is not associated with a real person. As such, symmetric biometric profiles can be used with a biometric verification system without exposing any of the biometric information of the plurality of natural biometric profiles. In some implementations, generating 104 the plurality of synthetic biometric profiles includes converting the plurality of random samples into a plurality of synthetic biometric profiles. In some implementations, synthetic cohort generation process 10 generates the plurality of synthetic biometric profiles by generating a plurality of random samples which each define a synthetic biometric profile. In this manner, by generating a plurality of random samples from the generative model, synthetic cohort generation process 10 generates a plurality of synthetic biometric profiles.

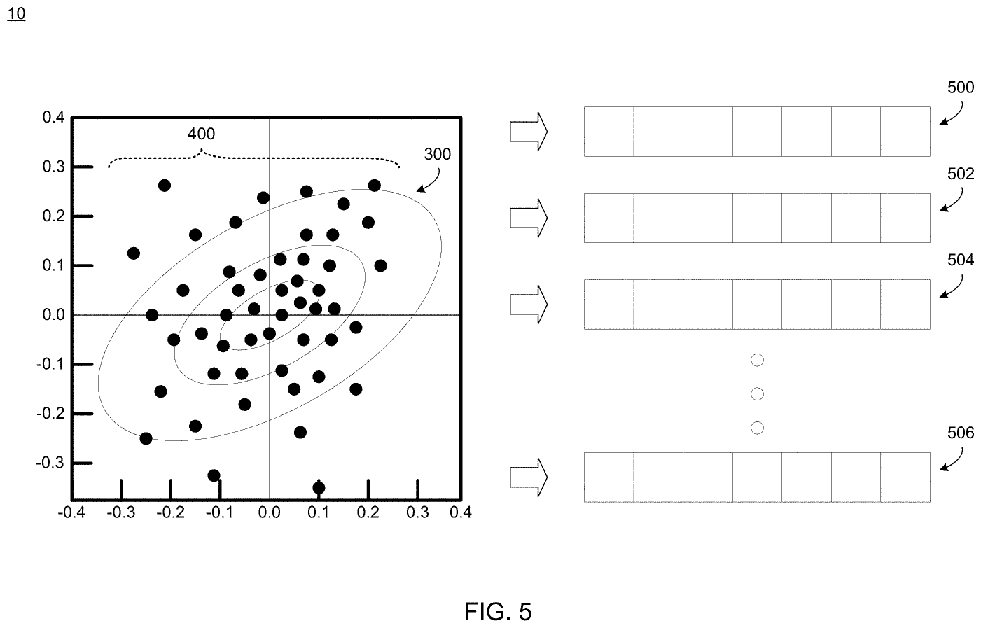

Referring also to FIG. 5, suppose synthetic cohort generation process 10 generates 102 a plurality of random samples (e.g., plurality of random samples 400) from generative model 300. As discussed above, plurality of random samples 400 has the same distribution as plurality of natural biometric profiles 200, 202, 204, 206 using generative model 300. With plurality of random samples 400, synthetic cohort generation process 10 generates a plurality of synthetic biometric profiles (e.g., synthetic biometric profiles 500, 502, 504, 506). In this example, each synthetic biometric profile includes biometric information that fits generative model 300 but is not attributable to an actual person.

In some implementations, synthetic cohort generation process 10 disposes 108 of the plurality of natural biometric profiles in response to generating the plurality of synthetic biometric profiles. For example, synthetic cohort generation process 10 generates 104 plurality of synthetic biometric profiles 500, 502, 504, 506 to include the distribution of features or properties of biometric information defined by generative model 300 without including biometric information from plurality of natural biometric profiles 200, 202, 204, 206. In this manner, synthetic cohort generation process 10 is able to process target biometric information using plurality of synthetic biometric profiles 500, 502, 504, 506 that include the same distribution of features as plurality of natural biometric profiles 200, 202, 204, 206 without exposing plurality of natural biometric profiles 200, 202, 204, 206.

Accordingly and in response to generating synthetic biometric profiles 500, 502, 504, 506, synthetic cohort generation process 10 disposes 108 of plurality of natural biometric profiles 200, 202, 204, 206. In one example, disposing 108 of natural biometric profiles includes deleting or otherwise removing natural biometric profiles from a storage device or other computing device. In this example, the natural biometric profiles are deleted which provides the highest level of adherence to various privacy laws, regulations, and other restrictions concerning sensitive content (i.e., biometric information associated with a particular individual).

In another example, disposing 108 of natural biometric profiles includes removing natural biometric profiles from inclusion or use by a biometric verification system. In this example, biometric information from natural biometric profiles is used to generate the generative model but can be retained for other uses (e.g., data augmentation, speech processing (in the case of voice biometric information), image processing (in the case of retinal or face print biometric information), etc.).

In some implementations, the plurality of synthetic biometric profiles define a cohort of voiceprints. As discussed above, score normalization techniques use a cohort of biometric profiles (e.g., an “impostor set” or “normalization set”) for computing normalization means and standard deviations. In some implementations, the plurality of synthetic biometric profiles (e.g., plurality of synthetic biometric profiles 500, 502, 504, 506) define a cohort of biometric profiles which are used for performing “impostor” tests against target biometric information (e.g., a sample of biometric information to verify) and for collecting normalization statistics. In some implementations and as will be discussed in greater detail below, the plurality of synthetic biometric profiles (e.g., plurality of synthetic biometric profiles 500, 502, 504, 506) define a cohort used by a biometric verification system for score normalization when verifying target biometric information.

In some implementations, synthetic cohort generation process 10 uses 110 the plurality of synthetic biometric profiles within a biometric verification system. A biometric verification system is a hardware and/or software system that verifies and/or identifies individuals using unique biometric characteristics. For example, biometric profiles associated with particular individuals are enrolled in the biometric verification system such that target biometric information is compared to each enrolled biometric profile for verification or identification. In some implementations, when comparing target biometric information to the enrolled biometric profiles, the biometric verification system generates a recognition score. As discussed above, the biometric verification system calibrates biometric recognition scores for improved accuracy using the distribution of the plurality of natural biometric profiles. In some implementations, synthetic cohort generation process 10 uses 110 the plurality of synthetic biometric profiles to calibrate the biometric recognition scores with the same distribution as the plurality of natural biometric scores. In this manner, the biometric verification system uses recognition scores calibrated with the plurality of synthetic biometric profiles without exposing the biometric information of the plurality of natural biometric profiles.

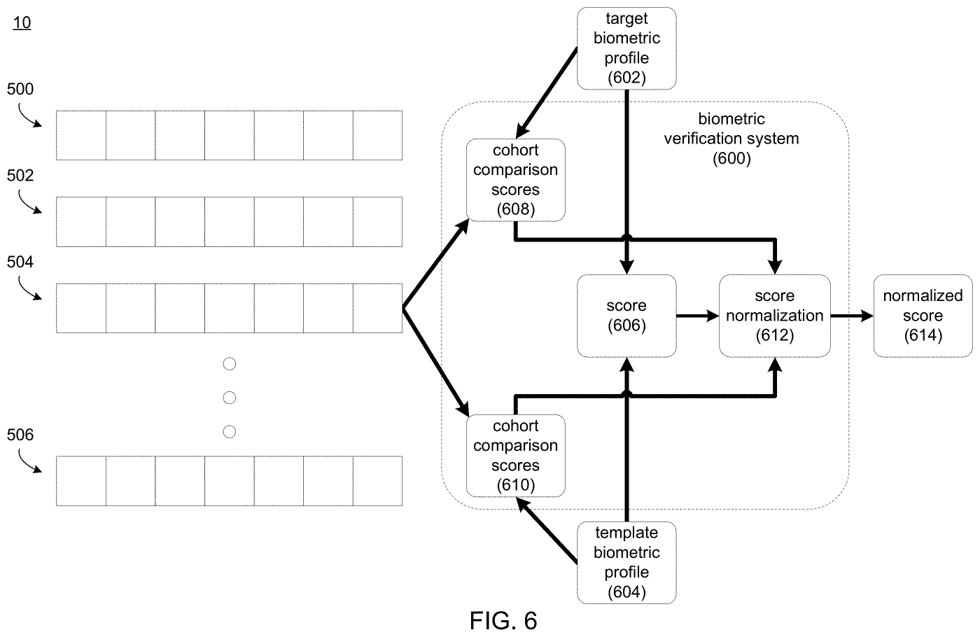

Referring also to FIG. 6, suppose synthetic cohort generation process 10 generates 104 plurality of synthetic biometric profiles 500, 502, 504, 506. In this example, synthetic cohort generation process 10 uses 110 plurality of synthetic biometric profiles 500, 502, 504, 506 to calibrate recognition scores of biometric verification system (e.g., biometric verification system 600). For example, suppose biometric verification system 600 receives a target biometric profile (e.g., target biometric profile 602) to verify against a template biometric profile (e.g., template biometric profile 604) of a plurality of biometric profiles. In this example, biometric verification system 600 generates a score (e.g., score 606) for the comparison of target biometric profile 602 with template biometric profile 604. For score normalization purposes, biometric verification system 600 generates scores (e.g., cohort comparison scores 608) for the comparison of target biometric profile 602 with plurality of synthetic profiles 500, 502, 504, 506 and scores (e.g., cohort comparison scores 610) for the comparison of template biometric profile 604 with plurality of synthetic profiles 500, 502, 504, 506. In this manner, the combination of score 606, cohort comparison scores 608, and cohort comparison scores 610 allows the comparison of target biometric profile 602 and template biometric profile 604 to be normalized using plurality of synthetic profiles 500, 502, 504, 506. In some implementations, biometric verification system 600 performs score normalization (e.g., represented as action 612) to generate a normalized score (e.g., normalized score 614).

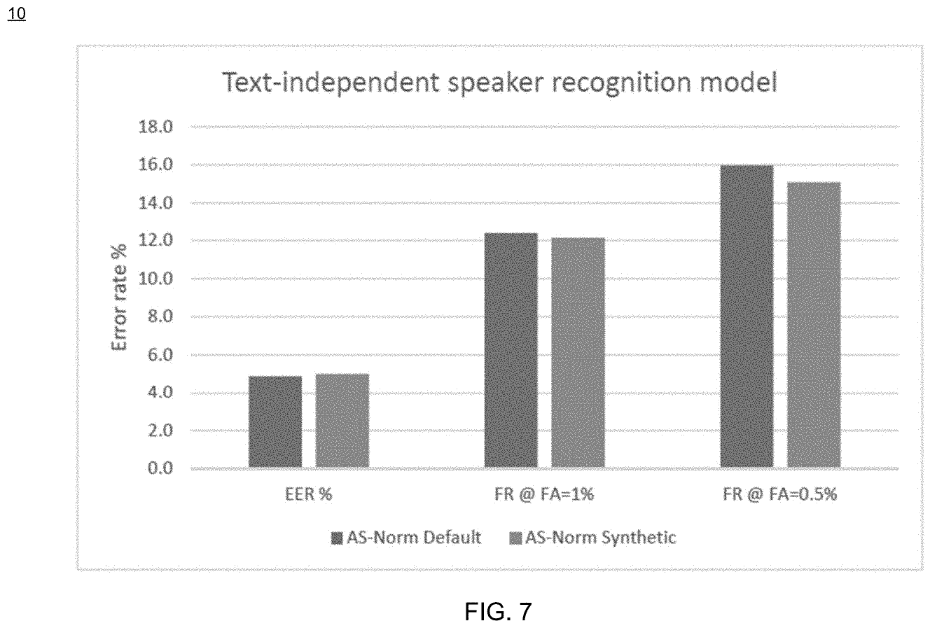

In some implementations, the accuracy of a biometric verification system that uses synthetic biometric profiles for score normalization is substantially similar to the accuracy observed when using natural biometric profiles for score normalization. In one example, suppose a text-independent speaker recognition model uses x-vectors to recognize speaker identities from target speech information. Now suppose, the speaker recognition model is used to perform speaker recognition using natural biometric profiles and synthetic biometric profiles. As shown in FIG. 7, the accuracy (in terms of an error rate percentage) is shown comparing the natural biometric profiles (e.g., AS-Norm Default) and the synthetic biometric profiles (e.g., AS-Norm Synthetic). In this example, the results are averaged across e.g., four test sets and are reported Table 1 below in terms of Equal Error Rate (EER) and False Rejection Rate (FR) at two False Acceptance (FA) values, 1% and 0.5%.

TABLE 1

| | EER % | FR @ FA = 1% | FR @ FA = 0.5% |
|---|---|---|---|
| AS-Norm Default | 4.89 | 12.39 | 15.98 |
| AS-Norm Synthetic | 5.01 | 12.14 | 15.09 |

As shown above in Table 1 and in FIG. 7, the synthetic biometric profiles perform similarly to the natural biometric profiles. In this manner, synthetic cohort generation process 10 is able to generate synthetic biometric profiles for score normalization in a biometric verification system that achieves similar accuracy to score normalization using natural biometric profiles without exposing natural biometric profiles.

### System Overview:

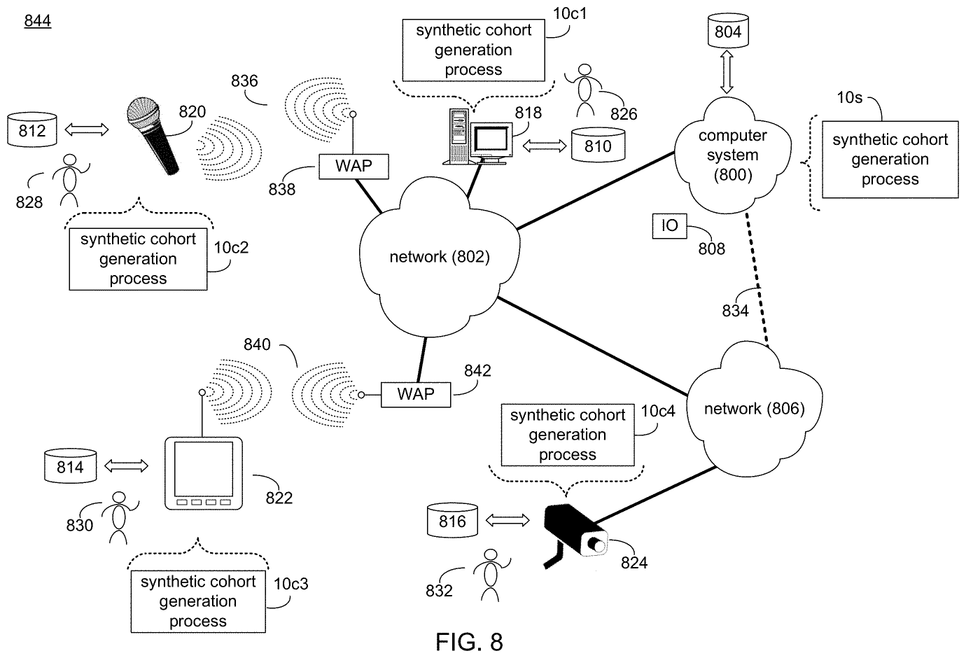

Referring to FIG. 8, there is shown synthetic cohort generation process 10. Synthetic cohort generation process 10 may be implemented as a server-side process, a client-side process, or a hybrid server-side/client-side process. For example, synthetic cohort generation process 10 may be implemented as a purely server-side process via synthetic cohort generation process 10s. Alternatively, synthetic cohort generation process 10 may be implemented as a purely client-side process via one or more of synthetic cohort generation process 10c1, synthetic cohort generation process 10c2, synthetic cohort generation process 10c3, and synthetic cohort generation process 10c4. Alternatively still, synthetic cohort generation process 10 may be implemented as a hybrid server-side/client-side process via synthetic cohort generation process 10s in combination with one or more of synthetic cohort generation process 10c1, synthetic cohort generation process 10c2, synthetic cohort generation process 10c3, and synthetic cohort generation process 10c4.

Accordingly, synthetic cohort generation process 10 as used in this disclosure may include any combination of synthetic cohort generation process 10s, synthetic cohort generation process 10c1, synthetic cohort generation process 10c2, synthetic cohort generation process 10c3, and synthetic cohort generation process 10c4.

Synthetic cohort generation process 10s may be a server application and may reside on and may be executed by a computer system 800, which may be connected to network 802 (e.g., the Internet or a local area network). Computer system 800 may include various components, examples of which may include but are not limited to: a personal computer, a server computer, a series of server computers, a mini computer, a mainframe computer, one or more Network Attached Storage (NAS) systems, one or more Storage Area Network (SAN) systems, one or more Platform as a Service (PaaS) systems, one or more Infrastructure as a Service (IaaS) systems, one or more Software as a Service (SaaS) systems, a cloud-based computational system, and a cloud-based storage platform.

A SAN includes one or more of a personal computer, a server computer, a series of server computers, a mini computer, a mainframe computer, a RAID device and a NAS system. The various components of computer system 800 may execute one or more operating systems.

The instruction sets and subroutines of synthetic cohort generation process 10s, which may be stored on storage device 804 coupled to computer system 800, may be executed by one or more processors (not shown) and one or more memory architectures (not shown) included within computer system 800. Examples of storage device 804 may include but are not limited to: a hard disk drive; a RAID device; a random access memory (RAM); a read-only memory (ROM); and all forms of flash memory storage devices.

Network 802 may be connected to one or more secondary networks (e.g., network 804), examples of which may include but are not limited to: a local area network; a wide area network; or an intranet, for example.

Various IO requests (e.g., IO request 808) may be sent from synthetic cohort generation process 10s, synthetic cohort generation process 10c1, synthetic cohort generation process 10c2, synthetic cohort generation process 10c3 and/or synthetic cohort generation process 10c4 to computer system 800. Examples of IO request 808 may include but are not limited to data write requests (i.e., a request that content be written to computer system 800) and data read requests (i.e., a request that content be read from computer system 800).

The instruction sets and subroutines of synthetic cohort generation process 10c1, synthetic cohort generation process 10c2, synthetic cohort generation process 10c3 and/or synthetic cohort generation process 10c4, which may be stored on storage devices 810, 812, 814, 816 (respectively) coupled to client electronic devices 818, 820, 822, 824 (respectively), may be executed by one or more processors (not shown) and one or more memory architectures (not shown) incorporated into client electronic devices 818, 820, 822, 824 (respectively). Storage devices 810, 812, 814, 816 may include but are not limited to: hard disk drives; optical drives; RAID devices; random access memories (RAM); read-only memories (ROM), and all forms of flash memory storage devices. Examples of client electronic devices 818, 820, 822, 824 may include, but are not limited to, personal computing device 818 (e.g., a smart phone, a personal digital assistant, a laptop computer, a notebook computer, and a desktop computer), audio input device 820 (e.g., a handheld microphone, a lapel microphone, an embedded microphone (such as those embedded within eyeglasses, smart phones, tablet computers and/or watches) and an audio recording device), display device 822 (e.g., a tablet computer, a computer monitor, and a smart television), machine vision input device 824 (e.g., an RGB imaging system, an infrared imaging system, an ultraviolet imaging system, a laser imaging system, a SONAR imaging system, a RADAR imaging system, and a thermal imaging system), a hybrid device (e.g., a single device that includes the functionality of one or more of the above-references devices; not shown), an audio rendering device (e.g., a speaker system, a headphone system, or an earbud system; not shown), various medical devices (e.g., medical imaging equipment, heart monitoring machines, body weight scales, body temperature thermometers, and blood pressure machines; not shown), and a dedicated network device (not shown).

Users 826, 828, 830, 832 may access computer system 800 directly through network 802 or through secondary network 806. Further, computer system 800 may be connected to network 802 through secondary network 806, as illustrated with link line 834.

The various client electronic devices (e.g., client electronic devices 818, 820, 822, 824) may be directly or indirectly coupled to network 802 (or network 806). For example, personal computing device 818 is shown directly coupled to network 802 via a hardwired network connection. Further, machine vision input device 824 is shown directly coupled to network 806 via a hardwired network connection. Audio input device 822 is shown wirelessly coupled to network 802 via wireless communication channel 836 established between audio input device 820 and wireless access point (i.e., WAP) 838, which is shown directly coupled to network 802. WAP 838 may be, for example, an IEEE 802.11a, 802.11b, 802.11g, 802.11n, Wi-Fi™, and/or Bluetooth™ device that is capable of establishing wireless communication channel 836 between audio input device 820 and WAP 838. Display device 822 is shown wirelessly coupled to network 802 via wireless communication channel 840 established between display device 822 and WAP 842, which is shown directly coupled to network 802.

The various client electronic devices (e.g., client electronic devices 818, 820, 822, 824) may each execute an operating system, wherein the combination of the various client electronic devices (e.g., client electronic devices 818, 820, 822, 824) and computer system 800 may form modular system 844.

### General:

As will be appreciated by one skilled in the art, the present disclosure may be embodied as a method, a system, or a computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product on a computer-usable storage medium having computer-usable program code embodied in the medium.

Any suitable computer usable or computer readable medium may be used. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. The computer-usable or computer-readable medium may also be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present disclosure may be written in an object-oriented programming language. However, the computer program code for carrying out operations of the present disclosure may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network/a wide area network/the Internet.

The present disclosure is described with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, may be implemented by computer program instructions. These computer program instructions may be provided to a processor of a general-purpose computer/special purpose computer/other programmable data processing apparatus, such that the instructions, which execute via the processor of the computer or other programmable data processing apparatus, create means for implementing the functions/acts specified in the flowchart and/or block diagram block or blocks.

These computer program instructions may also be stored in a computer-readable memory that may direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The flowcharts and block diagrams in the figures may illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, not at all, or in any combination with any other flowcharts depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

A number of implementations have been described. Having thus described the disclosure of the present application in detail and by reference to embodiments thereof, it will be apparent that modifications and variations are possible without departing from the scope of the disclosure defined in the appended claims.

What is claimed is:

1. A computer-implemented method, executed on a computing device, comprising:
generating a generative model representative of a plurality of natural biometric profiles;
generating a plurality of random samples from the generative model; and
generating a plurality of synthetic biometric profiles based upon, at least in part, the plurality of random samples.

2. The computer-implemented method of claim 1, wherein each natural biometric profile includes a vector of biometric information associated with an individual.

3. The computer-implemented method of claim 1, wherein generating the generative model includes generating a plurality of generative models for a plurality of biometric characteristics.

4. The computer-implemented method of claim 1, wherein the generative model is a multivariate Gaussian distribution.

5. The computer-implemented method of claim 1, wherein the plurality of synthetic biometric profiles define a cohort of voiceprints.

6. The computer-implemented method of claim 1, further comprising:
disposing of the plurality of natural biometric profiles in response to generating the plurality of synthetic biometric profiles.

7. The computer-implemented method of claim 1, further comprising:
using the plurality of synthetic biometric profiles within a biometric verification system.

8. A computing system comprising:
a memory; and
a processor to generate a generative model representative of a plurality of natural voiceprints, to generate a plurality of synthetic voiceprints by generating a plurality of random samples from the generative model, and to use the plurality of synthetic voiceprints within a biometric verification system.

9. The computing system of claim 8, wherein each voiceprint includes a vector of voiceprint information associated with an individual speaker.

10. The computing system of claim 8, wherein generating the generative model includes generating a plurality of generative models for a plurality of voice characteristics.

11. The computing system of claim 10, wherein the plurality of voice characteristics include at least one of:
speaker age;
speaker language; and
speaker gender.

12. The computing system of claim 8, wherein the generative model is a multivariate Gaussian distribution.

13. The computing system of claim 8, wherein the processor is further configured to:
dispose of the plurality of natural voiceprints in response to generating the plurality of synthetic voiceprints.

14. The computing system of claim 8, wherein the plurality of synthetic voiceprints define a cohort of voiceprints.

15. A computer program product residing on a non-transitory computer readable medium having a plurality of instructions stored thereon which, when executed by a processor, cause the processor to perform operations comprising:
generating a generative model representative of a plurality of natural voiceprints;
generating a plurality of random samples from the generative model; and
generating a plurality of synthetic voiceprints based upon, at least in part, the plurality of random samples, wherein the plurality of synthetic voiceprints define a cohort of voiceprints for a biometric verification system.

16. The computer program product of claim 15, wherein each voiceprint includes a vector of voiceprint information associated with an individual speaker.

17. The computer program product of claim 15, wherein generating the generative model includes generating a plurality of generative models for a plurality of voice characteristics.

18. The computer program product of claim 17, wherein the plurality of voice characteristics include at least one of:
speaker age;
speaker language; and
speaker gender.

19. The computer program product of claim 15, wherein the operations further comprise:
disposing of the plurality of natural voiceprints in response to generating the plurality of synthetic voiceprints.

20. The computer program product of claim 15, wherein the operations further comprise:
using the plurality of synthetic voiceprints within the biometric verification system.
